(19) United States
(12) Patent Application Publication
(10) Pub. No.: US 2010/0258085 A1
(43) Pub. Date: Oct. 14, 2010

(54) COUPLING DEVICE

(76) Inventors: Edoardo Giorgetti, Rosignano Marittimo (LI) (IT); Giandomenico Serra, Loc.Ghezzano-S.Giuliano Terme (IT)

Correspondence Address: King & Spalding LLP, 401 Congress Avenue, Suite 3200, Austin, TX, 78701, US

(21) Appl. No.: 12/758,516

(22) Filed: Apr. 12, 2010

(30) Foreign Application Priority Data
Apr. 14, 2009 (EP) 09005322

(51) Int. Cl. F02M 37/04; B23P 11/00

(52) U.S. Cl. 123/470; 29/428

(57) ABSTRACT

A coupling device for hydraulically and mechanically coupling an injection valve to a fuel rail of a combustion engine has a fuel injector cup with a central longitudinal axis and can be hydraulically coupled to the fuel rail and engages a fuel inlet tube of the injection valve, a first retaining element is fixedly coupled to the cup, a second retaining element is fixedly coupled to the valve, the second element being coupled to the first element to prevent a movement of the second element relative to the first element in a first direction of the central longitudinal axis to retain the valve in the cup, and a damper element which is arranged axially between the cup and the valve body. The damper element limits a movement of the valve relative to the cup in a second direction of the central longitudinal axis opposing the first direction.

### CROSS-REFERENCE TO RELATED APPLICATIONS

This application claims priority to EP Patent Application No. 09005322 filed Apr. 14, 2009, the contents of which is incorporated herein by reference in its entirety

TECHNICAL FIELD

The invention relates to a coupling device for hydraulically and mechanically coupling a fuel injector to a fuel rail of a combustion engine.

### BACKGROUND

Coupling devices for hydraulically and mechanically coupling a fuel injector to a fuel rail are in widespread use, in particular for internal combustion engines. Fuel can be supplied to an internal combustion engine by the fuel rail assembly through the fuel injector. The fuel injectors can be coupled to the fuel injector cups in different manners.

In order to keep pressure fluctuations during the operation of the internal combustion engine at a very low level, internal combustion engines are supplied with a fuel accumulator to which the fuel injectors are connected and which has a relatively large volume. Such a fuel accumulator is often referred to as a common rail.

Known fuel rails comprise a hollow body with recesses in form of fuel injector cups, wherein the fuel injectors are arranged. The connection of the fuel injectors to the fuel injector cups that supply the fuel from a fuel tank via a low or high-pressure fuel pump needs to be very precise to get a correct injection angle and a sealing of the fuel.

### SUMMARY

According to various embodiments, a coupling device for hydraulically and mechanically coupling a fuel injector to a fuel rail can be created which is simply to be manufactured and which facilitates a reliable and precise connection between the fuel injector and the fuel injector cup without a resting of the fuel injector on the cylinder head.

According to an embodiment, a coupling device for hydraulically and mechanically coupling an injection valve to a fuel rail of a combustion engine, the injection valve comprising a valve body and a fuel inlet tube being arranged in the valve body, may comprise:—a fuel injector cup having a central longitudinal axis and being designed to be hydraulically coupled to the fuel rail and to engage the fuel inlet tube of the injection valve,—a first retaining element being fixedly coupled to the fuel injector cup, a second retaining element being fixedly coupled to the injection valve, the second retaining element being coupled to the first retaining element to prevent a movement of the second retaining element relative to the first retaining element in a first direction of the central longitudinal axis to retain the injection valve in the fuel injector cup, and—a damper element being arranged axially between the fuel injector cup and the valve body and being designed to limit a movement of the injection valve relative to the fuel injector cup in a second direction of the central longitudinal axis opposing the first direction.

According to a further embodiment, the damper element can be a spring. According to a further embodiment, the damper element can be a ring of a frustoconical shape. According to a further embodiment, the fuel injector cup may have an inner wall comprising a step facing the valve body and being designed to support the damper element in axial direction.

### BRIEF DESCRIPTION OF THE DRAWINGS

Exemplary embodiments are explained in the following with the aid of schematic drawings. These are as follows:

FIG. 1 an internal combustion engine in a schematic view,

FIG. 2 a longitudinal section through a fuel injector, and

FIG. 3 a longitudinal section through a coupling device.

Elements of the same design and function that occur in different illustrations are identified by the same reference character.

### DETAILED DESCRIPTION

According to various embodiments, a coupling device can be provided for hydraulically and mechanically coupling a fuel injector to a fuel rail of a combustion engine. The injection valve comprises a valve body and a fuel inlet tube being arranged in the valve body. The coupling device comprises a fuel injector cup having a central longitudinal axis and being designed to be hydraulically coupled to the fuel rail and to engage the fuel inlet tube of the injection valve, a first retaining element being fixedly coupled to the fuel injector cup, a second retaining element being fixedly coupled to the injection valve, the second retaining element being coupled to the first retaining element to prevent a movement of the second retaining element relative to the first retaining element in a first direction of the central longitudinal axis to retain the injection valve in the fuel injector cup, and a damper element. The damper element is arranged axially between the fuel injector cup and the valve body and is designed to limit a movement of the injection valve relative to the fuel injector cup in a second direction of the central longitudinal axis opposing the first direction.

This may have the advantage that only a little movement of the injection valve towards the injector cup is possible. The counterforce of the damper element is proportional to the axial deviation of the injection valve referring to a neutral rest position of the injection valve relative to the injector cup. Furthermore, the noise due to a contact between the injection valve and the injector cup can be kept small. The mounting and assembly of the fuel rail can be carried out in a simple manner.

In an embodiment the damper element is a spring. This has the advantage that the rest position of the injection valve relative to the injector cup can be adjusted very exactly.

In a further embodiment the damper element is a ring of a frustoconical shape. This may allow a good coupling of the damper element with the fuel injector cup and the valve body. Furthermore, a simple design of the damper element is possible. Additionally, a long lifetime of the damper element with good maintenance of the spring characteristics is possible. No further components beside the damper element are necessary.

In a further embodiment the fuel injector cup has an inner wall comprising a step facing the valve body and being designed to support the damper element in axial direction. This may allow to obtain a sufficient large contact area between the damper element and the fuel injector cup. Consequently, a good coupling of the damper element with the fuel injector cup can be obtained.

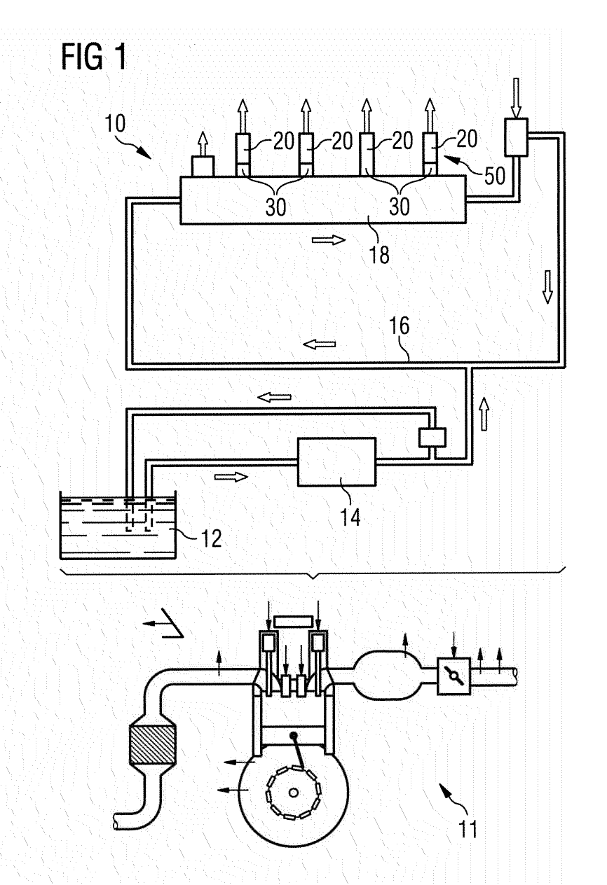

A fuel feed device 10 is assigned to an internal combustion engine 11 (FIG. 1) which can be a diesel engine or a gasoline engine. It includes a fuel tank 12 that is connected via a first fuel line to a fuel pump 14. The output of the fuel pump 14 is connected to a fuel inlet 16 of a fuel rail 18. In the fuel rail 18, the fuel is stored for example under a pressure of about 200 bar in the case of a gasoline engine or of about more than 2,000 bar in the case of a diesel engine. Fuel injectors 20 are connected to the fuel rail 18 and the fuel is fed to the fuel injectors 20 via the fuel rail 18.

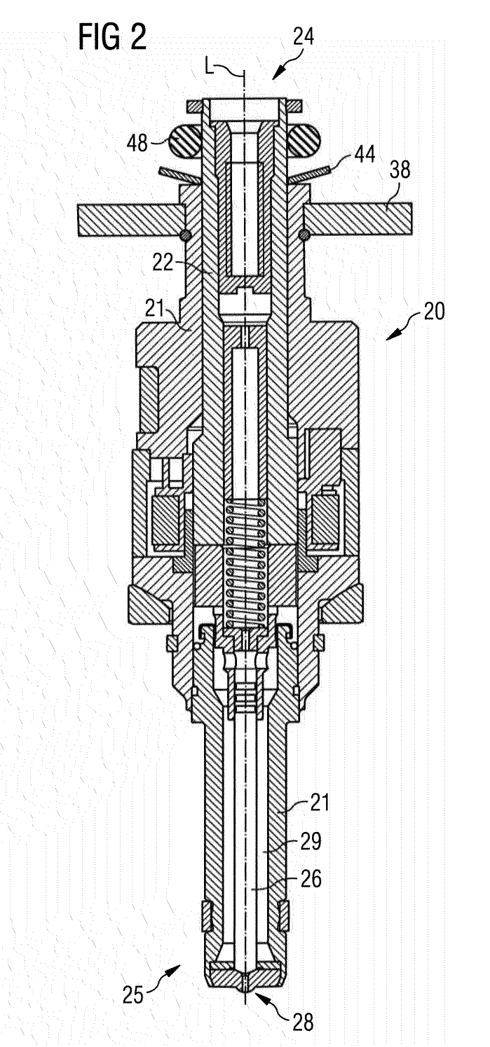

FIG. 2 shows the fuel injector 20 in detail. The fuel injector 20 is suitable for injecting fuel into a combustion chamber of the internal combustion engine 11. The fuel injector 20 comprises a central longitudinal axis L and has a valve body 21. Inside the valve body 21 a fuel inlet tube 22 is arranged partially. The fuel inlet tube 22 comprises a fuel inlet portion 24 of the fuel injector 20. Furthermore, the fuel injector 20 has a fuel outlet portion 25.

The fuel injector 20 comprises a valve needle 26 taken in a cavity 29 of the valve body 21. On a free end of the fuel injector 20 an injection nozzle 28 is formed which is closed or opened depending on the position of the valve needle 26 due to an axial movement of the valve needle 26. In a closing position of the valve needle 26 a fuel flow through the injection nozzle 28 is prevented. In an opening position fuel can flow through the injection nozzle 28 into a combustion chamber of the internal combustion engine 11.

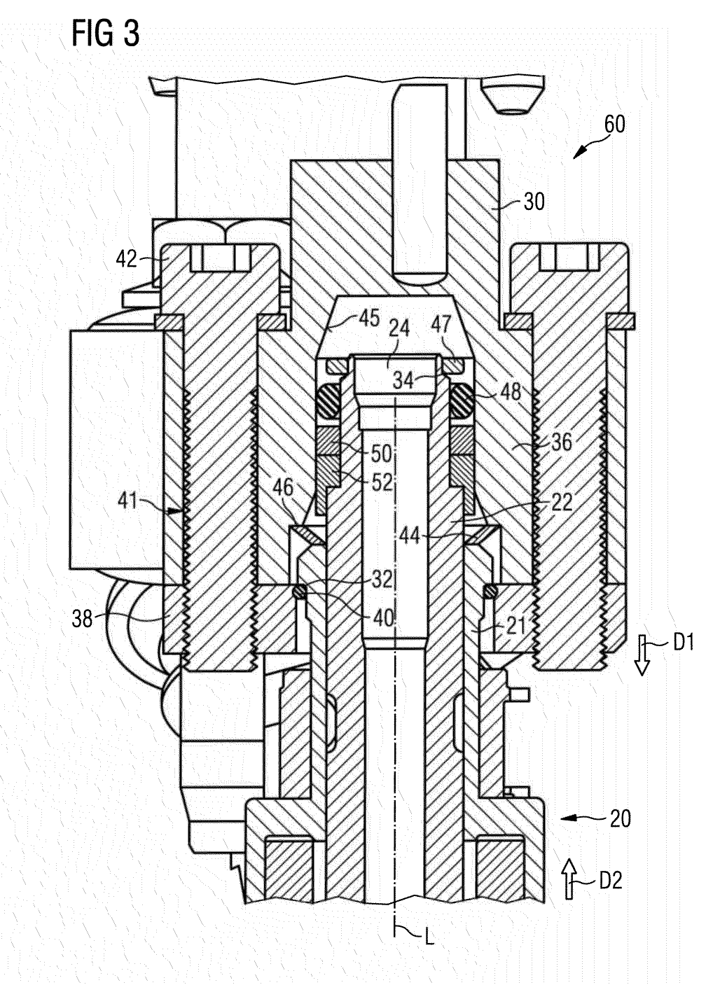

FIG. 3 shows a coupling device 60 which is coupled to the fuel rail 18 of the internal combustion engine 11. The valve body 21 has a groove 32, the fuel inlet tube 22 has a recess 34. The coupling device 60 comprises a fuel injector cup 30, a first retaining element 36 and a second retaining element 38, a snap ring 40 arranged in the groove 32, at least a screw 42 and a damper element 44, the parts of the coupling device 60 being described in the following.

The fuel injector cup 30 comprises an inner wall 45 and is hydraulically coupled to the fuel rail 18. Furthermore, the fuel injector cup 30 is in engagement with the fuel inlet tube 22 of the fuel injector 20.

The inner wall 45 has a step 46 which faces the valve body 21. The step 46 supports the damper element 44 in axial direction.

At an axial end of the fuel inlet tube 22 facing the inner wall 45 a washer 47 is arranged in the recess 34 of the fuel inlet tube 22.

On an outer surface of the fuel inlet tube 22 a sealing ring 48 is arranged which is in sealing contact with the inner wall 45 of the fuel injector cup 30. Additionally, a backup ring 50 and a backup ring support 52 are arranged radially between the outer surface of the fuel inlet tube 22 and the fuel injector cup 30.

The first retaining element 36 is in one piece with the fuel injector cup 30. In further embodiments the first retaining element 36 can be a separate part which is fixedly coupled to the fuel injector cup 30.

The second retaining element 38 is in engagement with the snap ring 40 which is arranged in the groove 32 of the valve body 21. The snap ring 40 enables a positive fitting coupling between the second retaining element 38 and the fuel injector 20. Consequently, the second retaining element 38 is fixedly coupled to the fuel injector 20.

Preferably, the first retaining element 36 may have a through hole 41. The first retaining element 36 and the second retaining element 38 are fixedly coupled with each other by the screw 42 which is received by the through hole 41 of the first retaining element 36 and is screwed into the second retaining element 38. This prevents a movement of the second retaining element 38 relative to the first retaining element 36 in a first direction D1.

The positive fitting coupling between the second retaining element 38 and the fuel injector 20 prevents a movement of the fuel injector 20 relative to the second retaining element 38 in the first direction D1.

As the first retaining element 36 is fixedly coupled to the fuel injector cup 30, the second retaining element 38 is fixedly coupled to the fuel injector 20 and the first retaining element 36 is fixedly coupled to the second retaining element 38, the fuel injector 20 is retained in the fuel injector cup 30 in direction of the central longitudinal axis L. This arrangement is also named a suspended fuel injector.

The damper element 44 is arranged axially between the step 46 at the inner wall 45 of the fuel injector cup 30 and the valve body 21. Preferably, the damper element 44 can be a spring.

Preferably, the damper element 44 can be shaped as a frustoconical ring.

Preferably, the damper element 44 can be of a material comprising steel which has good mechanical properties in view of elasticity. Furthermore, the lifetime of the damper element 44 comprising steel is very high. In an embodiment the damper element 44 consists of steel.

The damper element 44 limits the movement of the injection valve 20 relative to the fuel injector cup 30 in a second direction D2 of the central longitudinal axis L. The first direction D1 and the second direction D2 are opposing directions of the central longitudinal axis L. By this, only a small movement of the injection valve 20 in the second direction D2 towards the inner wall 45 of the fuel injector cup 30 is possible.

The counterforce of the damper element 44 is proportional to the axial deviation of the injection valve 20 referring to a neutral rest position of the injection valve 20 relative to the fuel injector cup 30. Therefore, an elastic control of the axial movement of the injection valve 20 relative to the fuel injector cup 30 is possible. The injection valve 20 can be kept easily in its neutral rest position relative to the fuel injector cup 30 even in the case that the pressure in the combustion chamber is higher than the fuel pressure in the fuel rail 18.

As suspended injection valves are constructed in view of a low noise development, it may be very advantageous that the damper element 44 can avoid a direct contact between the injection valve 20 and the injector cup 30. Consequently, the noise due to the contact between the injection valve 20 and the fuel injector cup 30 can be kept small.

Additionally, the mounting and the assembly of the fuel rail can be carried out in a secure manner as the damper element 44 holds the valve body 21 in a close contact with the snap ring 40 as well as the snap ring 40 in a close contact with the second retaining element 38 due to the compression effect caused by the damper element 44.

The assembly of the fuel injector 20 according to the embodiment of FIG. 3 will be described in the following:

For the assembly process, the fuel inlet tube 22 is first shifted into the valve body 21. Then the frustoconical damper element 44 is shifted over the fuel inlet tube 22 until it comes in contact with the valve body 21. In the following, the backup ring support 52, the backup ring 50 and the sealing ring 48 are shifted over the outer surface of the fuel inlet tube 22 until they come into engagement with the fuel inlet tube 22. Finally, the washer 47 is shifted over the fuel inlet tube 22 until it comes into engagement with the recess 34 of the fuel inlet tube 22.

What is claimed is:

1. A coupling device for hydraulically and mechanically coupling an injection valve to a fuel rail of a combustion engine, the injection valve comprising a valve body and a fuel inlet tube being arranged in the valve body, the coupling device comprising:
a fuel injector cup having a central longitudinal axis and being designed to be hydraulically coupled to the fuel rail and to engage the fuel inlet tube of the injection valve,
a first retaining element being fixedly coupled to the fuel injector cup, a second retaining element being fixedly coupled to the injection valve, the second retaining element being coupled to the first retaining element to prevent a movement of the second retaining element relative to the first retaining element in a first direction of the central longitudinal axis to retain the injection valve in the fuel injector cup, and
a damper element being arranged axially between the fuel injector cup and the valve body and being designed to limit a movement of the injection valve relative to the fuel injector cup in a second direction of the central longitudinal axis opposing the first direction.

2. The coupling device according to claim 1, wherein the damper element is a spring.

3. The coupling device according to claim 1, wherein the damper element is a ring of a frustoconical shape.

4. The coupling device according to claim 1, wherein the fuel injector cup has an inner wall comprising a step facing the valve body and being designed to support the damper element in axial direction.

5. A coupling device for hydraulically and mechanically coupling an injection valve to a fuel rail of a combustion engine, the coupling device comprising:
a fuel injector cup having a central longitudinal axis and being designed to be hydraulically coupled to the fuel rail and to engage a fuel inlet tube of the injection valve, wherein the fuel inlet tube is arranged in a valve body,
a first retaining element being fixedly coupled to the fuel injector cup, a second retaining element being fixedly coupled to the injection valve, the second retaining element being coupled to the first retaining element to prevent a movement of the second retaining element relative to the first retaining element in a first direction of the central longitudinal axis to retain the injection valve in the fuel injector cup, and
a damper element being arranged axially between the fuel injector cup and the valve body and being designed to limit a movement of the injection valve relative to the fuel injector cup in a second direction of the central longitudinal axis opposing the first direction.

6. The coupling device according to claim 5, wherein the damper element is a spring.

7. The coupling device according to claim 5, wherein the damper element is a ring of a frustoconical shape.

8. The coupling device according to claim 5, wherein the fuel injector cup has an inner wall comprising a step facing the valve body and being designed to support the damper element in axial direction.

9. A method for hydraulically and mechanically coupling an injection valve to a fuel rail of a combustion engine, the injection valve comprising a valve body and a fuel inlet tube being arranged in the valve body, the method comprising the steps of:
providing a fuel injector cup having a central longitudinal axis and being designed to be hydraulically coupled to the fuel rail and to engage the fuel inlet tube of the injection valve,
coupling a first retaining element fixedly to the fuel injector cup, and a second retaining element fixedly to the injection valve, wherein the second retaining element being coupled to the first retaining element to prevent a movement of the second retaining element relative to the first retaining element in a first direction of the central longitudinal axis to retain the injection valve in the fuel injector cup, and
arranging a damper element axially between the fuel injector cup and the valve body to limit a movement of the injection valve relative to the fuel injector cup in a second direction of the central longitudinal axis opposing the first direction.

10. The method according to claim 9, wherein the damper element is a spring.

11. The method according to claim 9, wherein the damper element is a ring of a frustoconical shape.

12. The method according to claim 9, wherein the fuel injector cup has an inner wall comprising a step facing the valve body and being designed to support the damper element in axial direction.
